(19) United States
(12) Patent Application Publication
(10) Pub. No.: US 2015/0379353 A1
(43) Pub. Date: Dec. 31, 2015

(54) METHOD AND APPARATUS FOR ROLE IDENTIFICATION DURING MULTI-DEVICE VIDEO RECORDING

(71) Applicant: Nokia Corporation, Espoo (FI)

(72) Inventors: Sujeet Shyamsundar Mate, Tampere (FI); Igor Danilo Diego Curcio, Tampere (FI); Francesco Cricri, Tampere (FI)

(21) Appl. No.: 14/317,832

(22) Filed: Jun. 27, 2014

(51) Int. Cl. G06K 9/00; G06K 9/46

(52) U.S. Cl. CPC G06K 9/00711; G06K 9/4671

(57) ABSTRACT

A method, apparatus and computer program product are provided to effectively and efficiently summarize the video of an event captured by a plurality of image capturing devices, such as by the creation of a remix. In the context of a method, user input is received that designates video content from a respective device to be utilized for semantic analysis. The method also includes analyzing, with a processor, the video content to identify one or more salient events. Further, the method includes causing to be provided information regarding designation of video content for semantic analysis and information regarding the one or more salient events.

### TECHNOLOGICAL FIELD

An example embodiment of the present invention relates generally to multi-device video recording and, more particularly, to role identification for an image capturing device during multi-device video recording, such as to facilitate cooperative video summarization and/or remix creation.

### BACKGROUND

Video of an event may be recorded by a number of different image capturing devices. While the image capturing devices may all record video of the same event, such as a sporting event, a concert, a performance or any other type of event, each image capturing device may record video of the event in a manner that is at least somewhat different than the manner in which video of the event is recorded by other image capturing devices. For example, the image capturing devices may be positioned at different locations such that the direction and the perspective of the video recorded by the various image capturing devices are different. Additionally, the resolution, the view settings, e.g., wide angle view, midrange view or close-up view, or other recording parameters with which an image capturing devices records video of an event may vary from image capturing device to device.

By way of example, images of an event may be recorded both by one or more professional cameras, as well as one or more image capturing devices embodied by mobile devices, such as cellular telephones, video recorders or the like. The professional cameras generally capture video of the event at a much greater resolution than the image capturing devices embodied by mobile devices. Moreover, the professional cameras may be capable of capturing close-up images of the participants in the event that the image capturing devices embodied by mobile devices are unable to capture. However, professional cameras may generally be positioned further from the event than the image capturing devices embodied by mobile devices. In this regard, professional cameras may be positioned some distance away from the event so as not to block the view of spectators of the event. Conversely, the image capturing devices embodied by mobile devices may sometimes be positioned immediately proximate or at least much closer to the event than the professional cameras. As such, the image capturing devices embodied by mobile devices may capture an unimpeded full or wide angle view of the event from a relatively close location, albeit sometimes at a lower resolution or quality.

In order to facilitate a review of an event and/or the video of an event, a summary of the video recorded of an event may be created. In instances in which video of an event is recorded by a plurality of image capturing devices, the summary may be enhanced by combining portions of the video recorded by the plurality of image capturing devices in order to cooperatively create a summarization or remix of the video of the event. In order to provide an effective summary of the event and to enhance the user experience, the remix is preferably of a relatively high quality and is compiled in a manner that summarizes the video of the event in a manner that includes many or each of the salient portions of the event. However, with the multiplicity of image capturing devices that capture video of the event, the summarization of the event and the creation of a remix in an efficient and effective manner may sometimes prove challenging.

### BRIEF SUMMARY

A method, apparatus and computer program product are provided in accordance with an example embodiment in order to effectively and efficiently summarize the video of an event captured by a plurality of image capturing devices, such as by the creation of a remix. In this regard, the method, apparatus and computer program product of an example embodiment may provide for role identification during a multi-device video recording such that the summarization of the video, such as in terms of the creation of a remix, may be performed efficiently while creating a summary or remix that is of high quality. For example, the method, apparatus and computer program product of an example embodiment may provide for an image capturing device to be identified in such a manner that the content provided by the respective image capturing device is utilized for semantic analysis so as to identify one or more salient events within the video, while portions of the video content from other image capturing devices that are defined based upon the salient event(s) identified by the semantic analysis are utilized as the content of the summarization or the remix.

In an example embodiment, a method is provided that includes receiving user input designating video content from a respective device to be utilized for semantic analysis. The method of this example embodiment also includes analyzing, with a processor, the video content to identify one or more salient events. Further, the method of this example embodiment includes causing to be provided information regarding designation of video content for semantic analysis and information regarding the one or more salient events.

The method of an example embodiment may also include causing presentation of a query regarding the designation of the video content from a respective device to be utilized for semantic analysis or for subsequent viewing. In this example embodiment, the user input is received in response to the query. In this example embodiment, the method may further include determining a semantic analysis suitability factor based upon event type information or objects of interest within the video content. In this regard, the method may cause presentation of the query regarding the designation of video content based upon the semantic suitability factor.

The method of an example embodiment may cause to be provided information regarding one or more salient events that includes marker information for the one or more salient events. The method of an example embodiment may also include causing to be provided to one or more other devices information regarding the designation of the video content for semantic analysis. The one or more other devices of this example embodiment are also configured to capture video content. The method of an example embodiment may also include causing a content representation file to be provided to permit temporal information about the one or more salient events to be determined by the one or more other devices. The user input designating the video content to be utilized for semantic analysis may be received prior to or during capture of the video content. Alternatively, the user input designating the video content to be utilized for semantic analysis may be received after capture of other video content.

In another example embodiment, an apparatus is provided that includes at least one processor and at least one memory storing computer program code with the at least one memory and the computer program code configured to, with the processor, cause the apparatus to at least receive user input designating video content from a respective device to be utilized for semantic analysis. The at least one memory and the computer program code of this example embodiment are also configured to, with the processor, cause the apparatus to analyze the video content to identify one or more salient events. Further, the at least one memory and the computer program code of this example embodiment are configured to, with the processor, cause the apparatus to at least cause to be provided information regarding designation of the video content for semantic analysis and information regarding the one or more salient events.

The at least one memory and the computer program code may be further configured to, with the processor, cause the apparatus of an example embodiment to cause presentation of a query regarding the designation of the video content from the respective device to be utilized for semantic analysis or for subsequent viewing. In this example embodiment, the user input is received in response to the query. The at least one memory and the computer program code may be further configured to, with the processor, cause the apparatus of this example embodiment to determine a semantic analysis suitability factor based upon event-type information or objects of interest within the video content. The at least one memory and the computer program code may be configured to, with the processor, cause the apparatus of this example embodiment to cause presentation of the query regarding the designation of the video content based upon the semantic analysis suitability factor.

The at least one memory and the computer program code may be configured to, with the processor, cause the apparatus of an example embodiment to cause to be provided information regarding the one or more salient events by causing marker information for the one or more salient events to be provided. The at least one memory and the computer program code may be further configured to, with the processor, cause the apparatus of an example embodiment to cause to be provided to one or more other devices information regarding the designation of the video content for semantic analysis. The one or more other devices of this example embodiment are also configured to capture video content. The at least one memory and the computer program code may be further configured to, with the processor, cause the apparatus of an example embodiment to cause a content representation file to be provided to permit temporal information about the one or more salient events to be determined by the one or more other devices.

In a further example embodiment, a computer program product is provided that includes at least one non-transitory computer-readable storage medium having computer-executable program code instructions stored therein with the computer-executable program code instructions including program code instructions configured to receive user input designating video content from a respective device to be utilized for semantic analysis. The computer-executable program code instructions of this example embodiment also include program code instructions configured to analyze the video content to identify one or more salient events. The computer-executable program code instructions of this example embodiment further include program code instructions configured to cause to be provided information regarding designation of the video content for semantic analysis and information regarding the one or more salient events.

The computer-executable program code instructions of an example embodiment may further include program code instructions configured to cause presentation of a query regarding the designation of the video content from the respective device to be utilized for semantic analysis or for subsequent viewing. The user input is provided in this example embodiment in response to the query. The computer-executable program code instructions of this example embodiment may also include program code instructions configured to determine a semantic analysis suitability factor based upon event-type info ration or objects of interest within the video content. The program code instructions of this example embodiment may also be configured to cause presentation of the query regarding the designation of the video content based upon the semantic analysis suitability factor.

The program code instructions configured to cause to be provided information regarding the one or more salient events may include program code instructions configured to cause marker information for the one or more salient events to be provided. The computer-executable program code instructions of an example embodiment may further include program code instructions configured to cause to be provided to one or more other devices information regarding the designation of the video content for semantic analysis. In this regard, the one or more other devices may also be configured to capture video content. The computer-executable program code instructions of an example embodiment may further include program code instructions configured to cause a content representation file to be provided to permit temporal information about the one or more salient events to be determined by the one or more other devices.

In yet another example embodiment, an apparatus is provided that includes means for receiving user input designating the video content from a respective device to be utilized for semantic analysis. The apparatus of this example embodiment also includes means for analyzing the video content to identify one or more salient events. Further, the apparatus of this example embodiment includes means for causing to be provided information regarding designation of the video content for semantic analysis and information regarding the one or more salient events.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 is a representation of an event, such as a basketball game, with the locations of a plurality of image capturing devices configured to capture video of the event designated;

FIG. 2 is a block diagram of a system that may be specifically configured in accordance with an example embodiment of the present invention to provide for role identification during multi-device video recording;

FIG. 3 is a block diagram of an apparatus that may be specifically configured in accordance with an example embodiment of the present invention;

FIG. 4 is a flowchart illustrating operations performed, such as by the apparatus of FIG. 3, in accordance with an example embodiment of the present invention;

FIG. 5 is a representation of a query that may be presented to the user of an image capturing device in order to solicit user input designating the video content from the image capturing device to be utilized for semantic analysis in accordance with an example embodiment of the present invention; and

FIG. 6 is a block diagram of a system that may be specifically configured in accordance with another example embodiment of the present invention to provide for role identification during multi-device video recording.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

A method, apparatus and computer program product are provided in accordance with an example embodiment of the present invention in order to provide for role identification during multi-device video recording. In this regard, the video recorded by an image capturing device may be identified for use for semantic analysis or, alternatively, for subsequent viewing. If identified to be utilized for semantic analysis, information regarding the video recorded by the respective image capturing device may be utilized during the summarization of the video recorded by a plurality of other image capturing devices to identify the salient events to be included within the summarization or the remix. However, the actual video included within the summarization or the remix may be provided by the other image capturing devices that have recorded video that has been designated for subsequent viewing. Thus, the method, apparatus and computer program product of an example embodiment may utilize the different characteristics of the video recorded by a plurality of image capturing devices such that the video that is most effectively utilized for semantic analysis is utilized to determine the salient events within the video, but the video recorded by the other image capturing devices that is better suited for subsequent viewing, such as by being of higher quality or resolution, is included within the resulting summarization or remix with the portions of the video recorded by the other image capturing devices that is included in the summarization or remix being defined based upon the salient events identified by the semantic analysis. Thus, a summarization or remix may be cooperatively created in an efficient and effective manner with the resulting summarization or remix being of high quality so as to enhance the resulting user experience.

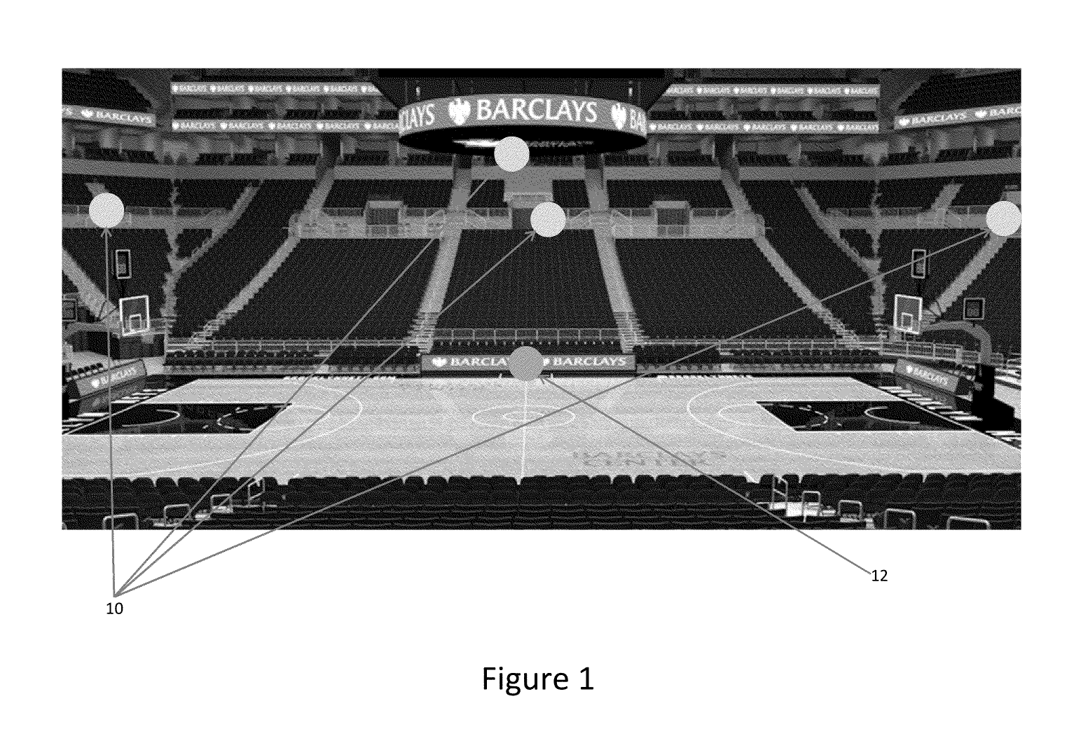

Referring now to FIG. 1, a representation of a venue at which a performance is to be recorded is depicted. In this example embodiment, the venue is a basketball arena and the performance is a basketball game to be played on the basketball court and to be viewed by the spectators who will fill the seats of the arena. However, the method, apparatus and computer program product of an example embodiment may be configured to construct a summary or a remix of the video of a performance at any of a wide variety of other venues and in conjunction with a wide variety of other types of performances, such as musical performances, plays or the like.

As shown in FIG. 1, video of the performance may be recorded by a plurality of image capturing devices, e.g., video capturing devices. The image capturing devices may be any of a wide variety of different types of image capturing devices. For example, the image capturing devices may include a camera or an electronic device that incorporates a camera that captures video content of the performance. In this regard, the image capturing devices may include a video recorder or a different electronic device, such as a mobile terminal, e.g., a mobile telephone, a smartphone, a personal digital assistant (PDA), a tablet computer, a laptop computer or the like, or another type of computing device, e.g., a personal computer or the like, that includes or is otherwise associated with a camera including, for example a video recorder. As another example, the image capturing device may be a professional video camera.

Regardless of the type of image capturing devices, the image capturing devices may be configured to record video of the performance. Although each of the image capturing devices may record video of the same performance, the video recorded by the image capturing devices may differ in a variety of manners. For example, the location from which the image capturing devices record video of the performance may differ with some image capturing devices being positioned closer to the performance than other image capturing devices. In addition, the image capturing devices may record different views of the event with some image capturing devices being configured to record video with a wide angle, while other image capturing devices are configured to capture close ups of one or more performers. Further, the video captured by some of the image capturing devices may be of a different quality or resolution, such as a higher quality or resolution, than the video captured by other image capturing devices.

In regards to the example depicted in FIG. 1, the plurality of image recording devices may include one or more professional cameras 10. The professional cameras are generally positioned some distance from the site of the performance, such as some distance from the basketball court, since the professional cameras are generally relatively large and may otherwise block the view of some of the spectators. As such, professional cameras may capture a view that includes more than just the site of the performance, such as by capturing a view that includes the basketball court as well as some region around the basketball court, e.g., the first few rows of seats filled with spectators. However, the professional cameras generally are configured to record video having a high quality, such as a high resolution. Additionally, the professional cameras may be configured to capture close ups of the performers that are not able to be obtained by other types of image capturing devices.

In addition to the one or more professional cameras 10, another type of image capturing device 12, such as a camera, e.g., a video recorder or the like, embodied by a mobile terminal, e.g., a mobile telephone, a smartphone, a personal digital assistant (PDA), a tablet computer or the like, may be configured to record video of the same performance. As shown, the image capturing device embodied by a mobile terminal may be positioned much closer to the performance than the professional cameras, such as courtside at the basketball game. However, the video recorded by the image capturing devices embodied by a mobile terminal may be of lower quality, such as lower resolution, than the video recorded by the professional cameras. Additionally, the video recorded by the image capturing device embodied by a mobile terminal may typically have a wide field of view, such as field of view that encompasses multiple or all performers, as opposed to the close ups that the professional cameras can capture. Although FIG. 1 depicts an example embodiment of a plurality of image capturing devices configured to record video of a basketball game, the plurality of image capturing devices may be any type of image capturing devices configured to record video of a plurality of different types of performances.

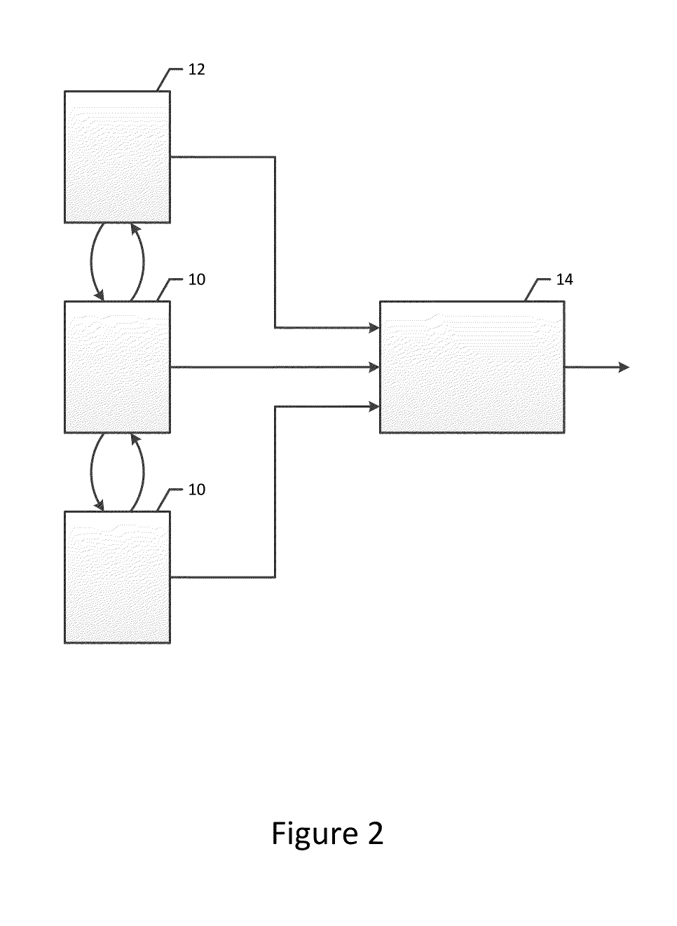

As shown in FIG. 2, the plurality of image capturing devices may be configured to communicate with a computing device 14 that is, in turn, configured to construct a summarization or remix of the performance based upon video captured by the plurality of image capturing devices. The computing device of an example embodiment may be embodied by or otherwise co-located with one of the image capturing devices or may be distributed amongst the plurality of image capturing devices. Alternatively, the computing device may be in communication with, but distinct and separate from the image capturing devices. In this example embodiment, the computing device may be embodied as a server, a personal computer, a computer workstation or the like. As shown in FIG. 2, the computing device is in communication with the image capturing devices utilizing any of a wide variety of communication techniques including wireline communications and/or wireless communications, such as cellular communications, wide area network (WAN) communications, local area network (LAN) communications or proximity-based communications, such as Bluetooth, Wi-Fi, near field communications (NFC) or other proximity-based communications techniques. Further, the image capturing devices may directly communicate with other image capturing devices, such as via wireless or wireline communication techniques including, for example, those described above in conjunction with communications with the computing device. Although not every image capturing device is shown to communicate with every other image capturing device in the embodiment of FIG. 2, the system of another example embodiment may be configured to permit each image capturing device to individually and directly communicate with every other image capturing device.

The image capturing devices that communicate with the computing device 14 include an image capturing device 12 that is configured to record video content that is utilized for semantic analysis as well as one or more image capturing devices 10 that are configured to record video content that is utilized to construct a summary or a remix of the video. Since the reliability with which semantic analysis is performed may depend upon maintaining a consistent shot angle, shot type and background, the video content recorded by an image capturing device 12 embodied by a mobile terminal in accordance with the example of FIG. 1 that captures an image of a substantial portion of the basketball court or other site for the performance from a close proximity may be utilized for semantic analysis even though the image resolution or quality may not be as good as the video content recorded by other image capturing devices 10. However, the video content recorded by the other image capturing devices 10 embodied by professional cameras may be included in the summarization or remix since the video content is of higher resolution or quality, even though the video content may be less suitable for the identification of salient events due to the shot angle, shot type, background or the like.

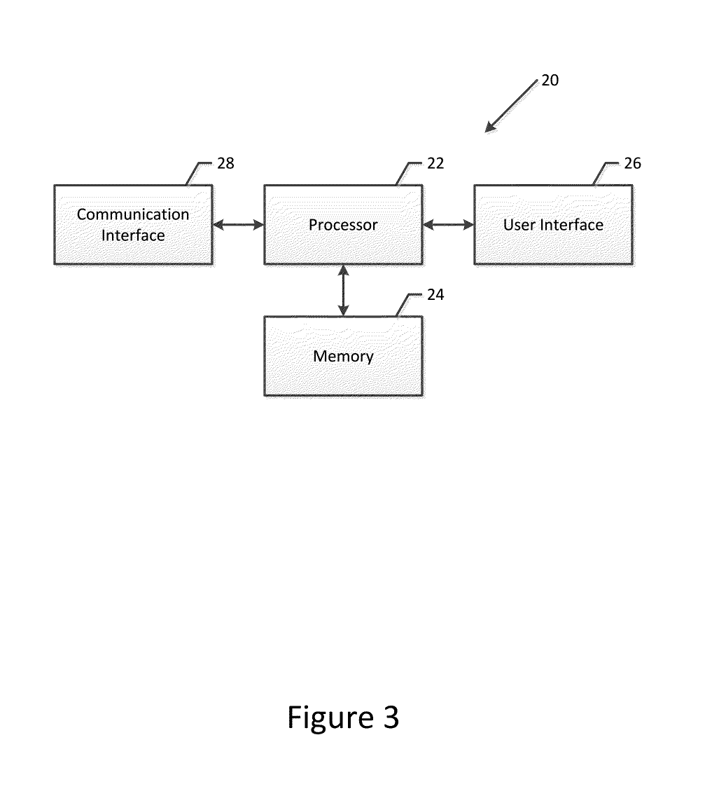

The image capturing device 12 that is configured to record video content that is utilized for semantic analysis may include, be associated with or otherwise be in communication with an apparatus 20, such as depicted in FIG. 3, that may be specifically configured in accordance with an example embodiment of the present invention. In this regard, the apparatus may include, be associated with or otherwise in communication with a processor 22, a memory device 24, a user interface 26 and a communication interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by an image capturing device 12. However, in some embodiments, the apparatus may be embodied as a chip or chip set. In other words, the apparatus may comprise one or more physical packages (for example, chips) including materials, components and/or wires on a structural assembly (for example, a circuit board). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the image capturing device 12) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 26. The user interface may include a touch screen display, a keyboard, a mouse, a joystick or other input/output mechanisms. In some embodiments, the user interface, such as a display, speakers, or the like, may also be configured to provide output to the user. In this example embodiment, the processor 22 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 24, and/or the like).

The apparatus 20 of the illustrated embodiment may also include a communication interface 28 that may be any means such as a device or circuitry embodied in either hardware or a combination of hardware and software that is configured to receive and/or transmit data from/to a computing device 14 and/or other image capturing devices 10 in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication.

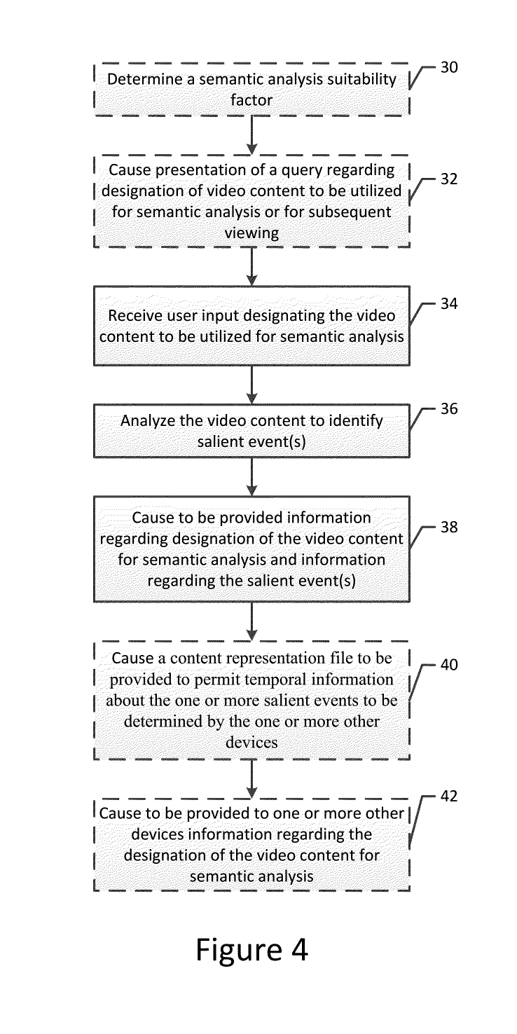

Referring now to FIG. 4, the operations performed, such as by the apparatus 20 of FIG. 3, in order to provide role identification during multi-device video recording are illustrated. As shown in block 34, the apparatus may include means, such as the processor 22, the user interface 26 or the like, for receiving user input designating video content recorded by the respective image capturing device 12 to be utilized for semantic analysis, as opposed to be being utilized for subsequent viewing in a summarization or remix of the video of a respective performance. The designation of the video content to be utilized for semantic analysis may be applicable to all video content captured by the image capturing device or for one or more specific videos. For example, a single video captured by an image capturing device may be designated to be utilized for semantic analysis but other video captured by the same image capturing device, such as in an instance in which the user position and, therefore, the position of the image capturing device has changed or the event focus location has changed relative to the location of the image capturing device such that the video captured by the image capturing device is no longer best utilized for semantic analysis. The user input may be provided in various manners. In an example embodiment, the apparatus may include means, such as the processor, the user interface or the like, for causing a query to be presented. See block 32. In this example embodiment, the query relates to the designation of the video content recorded by the image capturing device to be utilized either for semantic analysis or for subsequent viewing, such as by inclusion within a resulting summarization or remix.

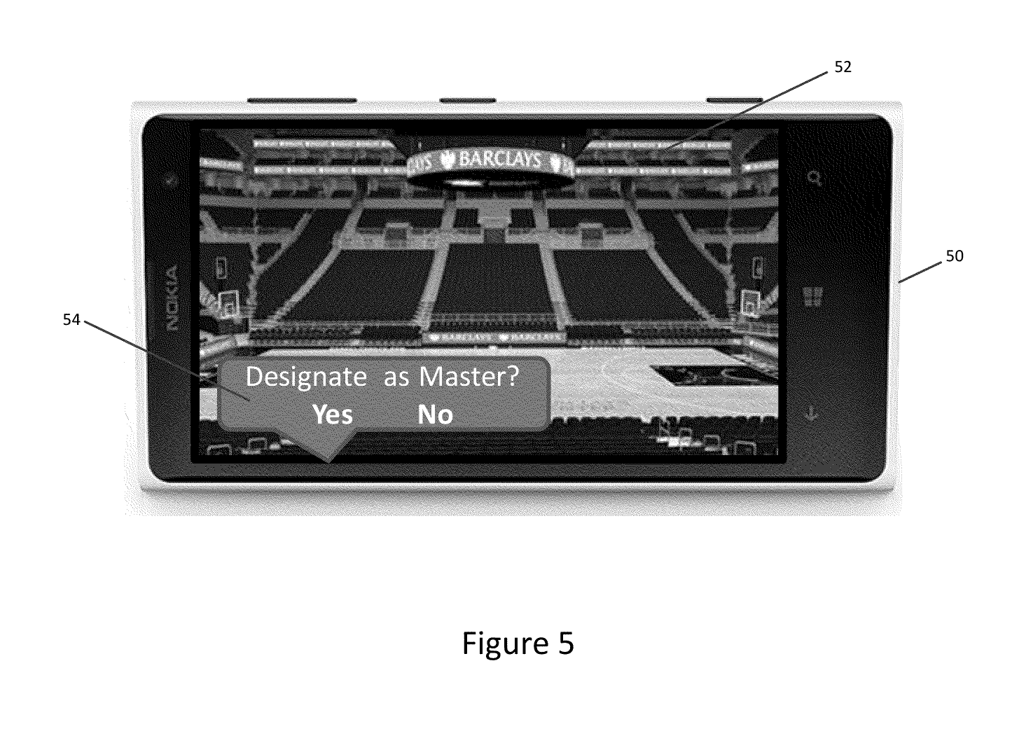

By way of example, the apparatus 20, such as the processor 22, may be configured to cause the query to be presented by the user interface 26, such as upon the display, of the image capturing device 12, such as a smartphone or other mobile terminal. In this example embodiment depicted in FIG. 5 in which the image capturing device is embodied by a mobile terminal 50, e.g., a smartphone, the apparatus, such as the processor, may be configured to pose a question 54 upon the display 52 as to whether the mobile terminal is to be designated as the master device such that the video recorded by the mobile terminal will be utilized for semantic analysis. While one example is depicted in FIG. 5, the query may be presented in various manners and need not inquire as to whether the image capturing device is to be a master device or a slave device. Instead, the query may ask the user to designate whether the video content recorded by the respective image capturing device is to be utilized for semantic analysis or for subsequent viewing in a summarization or remix. Regardless of the manner in which the query is presented, the user input may be received by the apparatus, such as a processor, the user interface or the like, in response to the query, as shown in block 34.

While the apparatus 20, such as the processor 22, the user interface 26 or the like, may be configured to simply ask the user as to whether the image capturing device is to be a master device or a slave device or, alternatively, whether the content recorded by the respective image capturing device is to be utilized for semantic analysis or for subsequent viewing, the apparatus may include means, such as the processor or the like, for analyzing the content recorded by the image capturing device and for causing presentation of the query based upon the results of the analysis of the video that has been captured. For example, the apparatus may include means, such as the processor or the like, for determining a semantic analysis suitability factor and then causing presentation of the query based upon the semantic analysis suitability factor. See blocks 30 and 32 of FIG. 4. Although the semantic analysis suitability factor may be determined in various manners, the apparatus, such as the processor, may be configured to determine the semantic analysis suitability factor based upon event-type information or objects of interest within the video content. In this regard, the user may initially identify the event-type information and/or objects of interest that will signify salient events within the video content. Alternatively, the event-type information and the objects of interest may be predefined. In this alternative embodiment, the predefined event-type information and objects of interest may be presented to the user, such as via the user interface, e.g., the display, and the user may be permitted to modify the event-type information and the objects of interest, such as by deleting from or adding to the event-type information and the objects of interest that will be utilized to identify salient events within the video content.

The apparatus 20, such as the processor 22, may be configured to determine the semantic analysis suitability factor based upon the event-type information and/or the objects of interest in various manners. For example, the apparatus, such as the processor, may be configured to determine the semantic analysis suitability factor to be proportional to the event-type information or the number of objects of interest that is identified within the video content. Thus, video recorded by the respective image capturing device that includes a greater amount of event-type information, such as information that has been predefined to identify or otherwise designate events of import or interest, such as salient events, may have a greater semantic analysis suitability factor in one example embodiment. Similarly, in an instance in which the apparatus, such as the processor, determines that the video recorded by the image capturing device includes a greater number of objects of interest, the semantic analysis suitability factor may again be greater. Conversely, in instances in which the video recorded by the respective image capturing device includes a lesser amount of event-type information and/or fewer objects of interest, the semantic analysis suitability factor may be smaller.

The apparatus 20, such as the processor 22, of an example embodiment may therefore be configured to determine whether the video captured by a respective image capturing device is suitable or preferred for semantic analysis in that the video will readily permit various salient events to be identified based upon the semantic analysis suitability factor. In this regard, the apparatus, such as the processor, of an example embodiment may be configured determine that the video captured by a respective image capturing device is suitable or preferred for semantic analysis in an instance in which the semantic analysis suitability factor satisfies a predefined threshold, such as by exceeding the predefined threshold. Alternatively, the apparatus, such as the processor, of this example embodiment may be configured determine that the video captured by a respective image capturing device is not suitable or not preferred for semantic analysis in an instance in which the semantic analysis suitability factor fails to satisfy a predefined threshold, such as by falling below the predefined threshold.

Based upon the analysis of the video, such as the determination of the semantic analysis suitability factor, the apparatus 20, such as the processor 22, of an example embodiment may be configured to cause a query to be presented regarding the designation of the video content for semantic analysis or for subsequent viewing depending upon the results of the analysis, such as the semantic analysis suitability factor. For example, in an instance in which the apparatus, such as the processor, determines that the video captured by a respective image capturing device 12 is suitable or preferred for semantic analysis, such as in an instance in which the semantic analysis suitability factor satisfies a predefined threshold, the apparatus, such as the processor, may be configured to cause a query to be presented that suggests to the user that the image capturing device be a master device or otherwise permit the video to be utilized for semantic analysis. Alternatively, in an instance in which the apparatus, such as the processor, determines that the video captured by a respective image capturing device is not suitable or preferred for semantic analysis, such as in an instance in which the semantic analysis suitability factor fails to satisfy a predefined threshold, the apparatus, such as the processor, may be configured to either cause no query to be presented or to cause a query to be presented that suggests to the user that the image capturing device be a slave device or otherwise permit the video to be utilized for subsequent viewing, but not for semantic analysis.

As described above and in response to the query, user input may be received that confirms the respective image capturing device 12 to be a master device or to otherwise designate the video content recorded by the respective image capturing device to be utilized for semantic analysis. See block 34. While the user may provide user input that does not follow the suggestion provided by the apparatus 20, the apparatus, such as the processor 22, may be configured to frame the user query in a manner that at least suggests the desired designation of the video content as being either for semantic analysis or for subsequent viewing.

As described above in which the video content is analyzed and the query is presented in a manner that is based upon the analysis, the user input designating the video content to be utilized for semantic analysis or for subsequent viewing may be received after recordation of the video content. In this example embodiment, the video may be recorded by the image capturing device and stored in memory 24. Thereafter, the apparatus 20, such as the processor 22, may be configured receive user input, such as in response to a query, as to whether the content is to be utilized for semantic analysis or for subsequent viewing. For example, the user input may be provided directly in conjunction with the video stored in memory, such as by a server, a service or the like. Alternatively, the user input designating the video content to be utilized for semantic analysis or for subsequent viewing may be received prior to capture of the video content or during the capture of the video content.

As shown in block 36 of FIG. 4, the apparatus 20 may also include means, such as the processor 22 or the like, configured to analyze the video content recorded by the respective image capturing device 12 and to identify one or more salient events. This analysis may be performed subsequent to and in response to receipt of the user input indicates that the video content is to be utilized for semantic analysis. Alternatively, this analysis may be performed prior to the receipt of the user input that indicates that the video content is to be utilized for semantic analysis, such as during the determination of the semantic analysis suitability factor. The salient events that are identified may be defined in various manners. For example, salient events may be defined to be those portions of the video content that include event-type information or an object of interest, such as described above in conjunction with the determination of a semantic analysis suitability factor. For example, the salient events may include the initial appearance of each of a plurality of performers in a play, the beginning of each song in a musical, each play that culminates in a score in an athletic event, each event that evokes a predefined audible reaction from the spectators, such as an audible response that exceeds a predefined audible threshold, or the like.

The apparatus 20 of this example embodiment may also include means, such as the processor 22, the communication interface 28 or the like, for causing to be provided information regarding the designation of the video content for semantic analysis and information regarding the one or more salient events that have been identified. See block 38 of FIG. 4. The apparatus, such as the processor, the communication interface or the like, may be configured to cause the information regarding the designation of the video content for semantic analysis to be provided in various manners, such as by providing information designating the respective image capturing device as a master device or a slave device or, alternatively, designating the video content to be for semantic analysis or for subsequent viewing. The apparatus, such as the processor, the communication interface or the like, may be configured to cause the information regarding the designation of the video content to be provided in various manners. For example, the information regarding the designation of the video content and information regarding the salient events may be provided, such as metadata, independent of any video content from the respective image capturing device 12. Alternatively, the information regarding the designation of the video content and inforniation regarding the salient events may be provided in concert with video content or an audio track from the respective image capturing device 12. For example, the information regarding the designation of the video content and information regarding the salient events may be provided in-band with the video content itself or out-of-band relative to the video content. In an example embodiment, the information regarding the designation of video content for semantic analysis may be provided by the apparatus, such as the processor, the communication interface or the like, in-band as metadata within a media file that includes the video content. Alternatively, the information regarding the designation of video content for semantic analysis may be provided by the apparatus, such as the processor, the communication interface or the like, out-of-band relative to the video content, such as over hypertext transfer protocol (HTTP), session initiation protocol (SIP), real time streaming protocol (RTSP) or other transport protocol.

The information regarding the one or more salient events that have been identified may be provided in various manners. For example, the apparatus 20 may include means, such as the processor 22, the communication interface 28 or the like, for causing marker information for the one or more salient events to be provided. The marker information may include information that identifies the one or more salient events. For example, the marker information may identify a salient event in terms of elapsed time from the beginning of the video content or from a prior salient event. Alternatively, the marker information may identify a predefined sound or other characteristic of the video content that occurs concurrently with the salient event or that otherwise has a predefined temporal relationship to the salient event, thereby serving to identify the salient event.

As shown in block 40 of FIG. 4, the apparatus 20 of an example embodiment may also include means, such as the processor 22, communication interface 28 or the like, configured either to cause a content representation file to be provided to permit temporal information about the one or more salient events to be determined by the one or more other devices. A variety of different content representation files may be provided. For example, the content representation file may include the video content recorded by the respective image capturing device 12 that is provided at a lower resolution or in a less fulsome manner than the video content captured and provided by one or more other image capturing devices 10. Alternatively, the content representation file may include an audio track associated with the video content that is provided without the associated video content. Still further, the content representation file may include any other type of suitable content representation, such as a feature file corresponding to the audio, that allows determination of temporal information about the salient event(s). As shown in FIG. 2, for example, each of the image capturing devices including the image capturing device 12 that captures video content for semantic analysis and the image capturing devices 10 that capture video content for subsequent viewing may provide the video content or at least a portion thereof to the computing device 14 for creation of a summarization or remix of the performance that is the subject of the video content. In this example embodiment, the image capturing device 12 that records video content for semantic analysis may provide the video content at a lower resolution than the video content provided by the other image capturing devices 10. Additionally or alternatively, the image capturing device 12 that records video content for semantic analysis may provide less of the video content than the other image capturing devices 10. For example, the image capturing device 12 that is configured to record video content for semantic analysis may provide only those portions of the video content that immediately precede and include the salient events and not other portions of the video content that are less related to the salient events. As another example, the image capturing device 12 that records video content for semantic analysis may provide the audio track associated with the video content, but not the associated video content. As each of the foregoing examples illustrate, the image capturing device 12 that records video content for semantic analysis may cause sufficient content, such as lower resolution video content, selected sections of the video content or the audio track, to be provided in an efficient manner that requires less bandwidth than if the entirety of the video content were to be provided with greater resolution. However, the image capturing device 12 that records video content for semantic analysis still provides sufficient content to permit the salient events to be identified from the information relating to the salient events, such as by permitting the salient events to be identified within the video content provided by the other image capturing devices 10 that have a higher resolution and/or is more complete.

In addition to providing the information regarding the designation of the video content for semantic analysis, the apparatus 20 may include means, such as the processor 22, the communication interface 28 or the like, for causing to be provided to one or more other image capturing devices 10 information regarding the designation of the video content recorded by a respective image capturing device 12 for semantic analysis. In this regard, the other image capturing devices 10 are also configured to capture video content, such as video content of the same performance. Since the video content of the respective image capturing device 12 has been designated for semantic analysis, the other image capturing devices 10 may be configured to recognize that the video content captured and provided to the computing device 14 by the other image capturing devices 10 will be utilized for subsequent viewing and, as such, the other image capturing devices 10 may be configured to capture the video content at a greater resolution and in a more complete or fulsome manner, such as by including both audio and video tracks, to facilitate subsequent construction of the summarization or remix by the computing device.

In response to receipt of the video content captured and provided by the image capturing devices 10 and the information regarding the designation of the video content captured by respective image capturing device 12 for semantic analysis and information regarding the one or more salient events, the computing device 14, such as a processor of the computing device, may be configured to construct a summarization or remix of the video content of the performance. In this regard, the computing device, such as the processor, may be configured to utilize the information regarding the one or more salient events that is provided by the image capturing device 12 that is configured to capture video content designated for semantic analysis and to identify the one or more salient events within the video content provided by the other image capturing devices 10. For example, the computing device, such as the processor, may be configured to identify the one or more salient events within the video content provided by the other image capturing devices 10 based upon marker information that identifies the portion of the video content that includes the one or more salient events. The computing device, such as the processor, may then construct a summarization or remix of the video content of the performance by including those portions of the video content, such as only those portions of the video content, provided by the other image capturing devices 10 that includes the salient event(s) identified by the image capturing device 12 configured to record video content designated for semantic analysis. Thus, the computing device may reliably and assuredly identify the salient events by utilizing the information provided by the image capturing device 12 that is configured to record video content for semantic analysis.

In this regard, the reliability with which the salient events are identified may be enhanced as a result of the video content recorded by the respective image capturing device 12. For example, the video content may be from a location relatively close to the performance and may include a mid-range or wide-angle view of the performance in order to facilitate identification of the salient events in a more reliable manner than the video content of the same performance captured from a location further from the performance and/or that includes a greater number or percentage of close-ups. By utilizing the video content captured by the other image capturing devices 10, however, the resulting summarization or remix may be of a greater quality as a result of the greater resolution or quality of the video content captured by the other image recording devices and/or the more fulsome or complete nature of the video content captured and provided by the other image capturing devices. Thus, the resulting summarization or remix may be created in an efficient and effective manner so as to enhance the resulting user experience.

In an example embodiment, the computing device 14 may identify that two or more of the image capturing devices 10, 12 have provided information designating the video content recorded by the respective image capturing devices to be for semantic analysis. In this example embodiment, the computing device, such as the processor of the computing device, may be configured to determine a semantic analysis suitability factor for each image capturing device, such as based upon event-type information or objects of interest within the video context provided by the respective image capturing devices. The computing device, such as the processor, may identify the image capturing device that is configured to record video content that is most suitable for semantic analysis based upon a comparison of the semantic analysis suitability factors of the image capturing devices, thereby providing for the most reliable determination or identification of the salient events. In this regard, the computing device, such as the processor, may identify the image capturing device that records video with the greatest semantic analysis suitability factor to be most suitable for semantic analysis. As such, the computing device, such as the processor, may then notify the other image capturing device(s) that the video content recorded by the other image capturing device(s) is not for semantic analysis, but is, instead, for subsequent viewing.

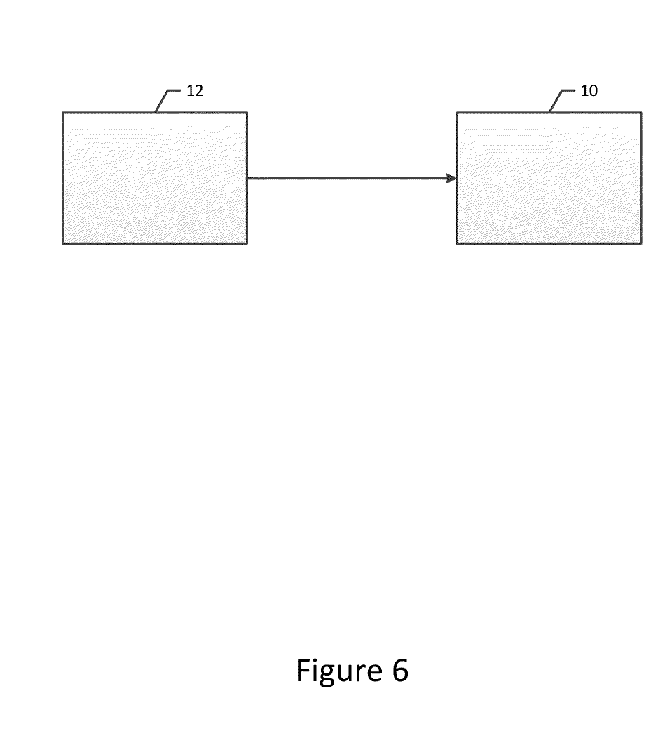

With reference now to the example embodiment of FIG. 6, one or more of the image capturing devices may be configured not only to record video content of the performance, but also to construct the summarization or remix of the video content of the performance. In this example embodiment, the image capturing devices may communicate with one another, such as via a wireless connection or a wireline connection including the examples described above. An image capturing device 12 may be configured to cause information regarding the designation of the video content recorded by the respective image capturing device for semantic analysis or for subsequent viewing to be provided and, in an instance in which the video content recorded by the respective image capturing device is to be utilized for semantic analysis, to also provide information regarding the one or more salient events. Further, the image capturing device may provide the video content that has been recorded, either in its entirety or portions thereof, or an audio track associated with the video content. The other image capturing device 10 that not only records video content of the performance, but also receives information from image capturing device 12 may then construct the summarization and remix in the manner described above. Although not depicted, the other image capturing device 10 of an example embodiment may also receive video content of the performance from other image capturing devices such that the summarization or remix is constructed based upon a combination of the video content of the performance.

During a performance, the video content recorded by the image capturing devices may change. For example, the location of one of the image capturing devices may be changed. As such, the determination as to which image capturing device should provide video content for semantic analysis and which image capturing devices should provide video content for subsequent viewing may correspondingly change. In this example, the method, apparatus 20 and computer program product of an example embodiment may therefore cause the video content provided by the image capturing devices to be differently processed in order to create the summarization or remix.

A method, apparatus 20 and computer program product are therefore provided in accordance with the foregoing example embodiments in order to effectively and efficiently summarize the video of an event captured by a plurality of image capturing devices, such as by the creation of a remix. In this regard, the method, apparatus and computer program product of an example embodiment recognizes that the properties of the video content that is utilized to most effectively identify salient events and the properties of the video content that is best utilized for subsequent viewing may be different such that the video content recorded by a respective image capturing device 12 may be utilized to identify salient events while the summarization or remix of a performance may be constructed from the video content recorded by other image capturing devices 10. By identifying the salient events utilizing the video content recorded by the image capturing device 12 that most effectively identifies salient events, the salient events may be identified with a higher rate of true positives and a lower rate of false negatives. In addition by constructing the summarization or remix of a performance from the video content that is best utilized for subsequent viewing, the quality of the summarization or remix may be increased. Moreover, by identifying the salient events as a result of the analysis of the video content recorded by a respective image capturing device 12, but not all image capturing devices, computational cost may be reduced by avoiding redundant content processing. Further, an example embodiment of the method, apparatus and computer program product may leverage a user's knowledge regarding the suitability of video content for semantic analysis or for viewing by receiving user input regarding the manner in which the video content recorded by an image capturing device is to be utilized.

As described above, FIG. 4 illustrates a flowchart of an apparatus 20, method and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as indicated by the boxes with dashed outlines in FIG. 4. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving user input designating video content from a respective device to be utilized for semantic analysis;
analyzing, with a processor, the video content to identify one or more salient events; and
causing to be provided information regarding designation of the video content for semantic analysis and information regarding the one or more salient events.

2. A method according to claim 1 further comprising causing presentation of a query regarding the designation of the video content from the respective device to be utilized for semantic analysis or for subsequent viewing, wherein the user input is received in response to the query.

3. A method according to claim 2 further comprising determining a semantic analysis suitability factor based upon event-type information or objects of interest within the video content, wherein causing presentation of the query regarding the designation of the video content comprises causing presentation of the query based upon the semantic analysis suitability factor.

4. A method according to claim 1 wherein causing to be provided information regarding the one or more salient events comprises causing marker information for the one or more salient events to be provided.

5. A method according to claim 1 further comprising causing to be provided to one or more other devices information regarding the designation of the video content for semantic analysis, wherein the one or more other devices are also configured to capture video content.

6. A method according to claim 1 further comprising causing a content representation file to be provided to permit temporal information about the one or more salient events to be determined by the one or more other devices.

7. A method according to claim 1 wherein the user input designating the video content to be utilized for semantic analysis is received prior to or during capture of the video content.

8. A method according to claim 1 wherein the user input designating the video content to be utilized for semantic analysis is received after capture of the video content.

9. An apparatus comprising at least one processor and at least one memory storing computer program code, the at least one memory and the computer program code configured to, with the processor, cause the apparatus to at least:
receive user input designating video content from a respective device to be utilized for semantic analysis;
analyze the video content to identify one or more salient events; and
cause to be provided information regarding designation of the video content for semantic analysis and information regarding the one or more salient events.

10. An apparatus according to claim 9 wherein the at least one memory and the computer program code are further configured to, with the processor, cause the apparatus to cause presentation of a query regarding the designation of the video content from the respective device to be utilized for semantic analysis or for subsequent viewing, wherein the user input is received in response to the query.

11. An apparatus according to claim 10 wherein the at least one memory and the computer program code are further configured to with the processor, cause the apparatus to determine a semantic analysis suitability factor based upon event-type information or objects of interest within the video content, wherein the at least one memory and the computer program code are configured to, with the processor, cause the apparatus to cause presentation of the query regarding the designation of the video content by causing presentation of the query based upon the semantic analysis suitability factor.

12. An apparatus according to claim 9 wherein the at least one memory and the computer program code are configured to, with the processor, cause the apparatus to cause to be provided information regarding the one or more salient events by causing marker information for the one or more salient events to be provided.

13. An apparatus according to claim 9 wherein the at least one memory and the computer program code are further configured to, with the processor, cause the apparatus to cause to be provided to one or more other devices information regarding the designation of the video content for semantic analysis, wherein the one or more other devices are also configured to capture video content.

14. An apparatus according to claim 9 wherein the at least one memory and the computer program code are further configured to, with the processor, cause the apparatus to cause a content representation file to be provided to permit temporal information about the one or more salient events to be determined by the one or more other devices.

15. A computer program product comprising at least one non-transitory computer-readable storage medium having computer-executable program code instructions stored therein, the computer-executable program code instructions comprising program code instructions configured to:
receive user input designating video content from a respective device to be utilized for semantic analysis;
analyze the video content to identify one or more salient events; and
cause to be provided information regarding designation of the video content for semantic analysis and information regarding the one or more salient events.

16. A computer program product according to claim 15 wherein the computer-executable program code instructions further comprise program code instructions configured to cause presentation of a query regarding the designation of the video content from the respective device to be utilized for semantic analysis or for subsequent viewing, wherein the user input is received in response to the query.

17. A computer program product according to claim 16 wherein the computer-executable program code instructions further comprise program code instructions configured to determine a semantic analysis suitability factor based upon event-type information or objects of interest within the video content, wherein program code instructions configured to cause presentation of the query regarding the designation of the video content comprise program code instructions configured to cause presentation of the query based upon the semantic analysis suitability factor.

18. A computer program product according to claim 15 wherein the program code instructions configured to cause to be provided information regarding the one or more salient events comprise program code instructions configured to cause marker information for the one or more salient events to be provided.

19. A computer program product according to claim 15 wherein the computer-executable program code instructions further comprise program code instructions configured to cause to be provided to one or more other devices information regarding the designation of the video content for semantic analysis, wherein the one or more other devices are also configured to capture video content.

20. A computer program product according to claim 19 wherein the computer-executable program code instructions further comprise program code instructions configured to cause a content representation file to be provided to permit temporal information about the one or more salient events to be determined by the one or more other devices.

21. An apparatus comprising:
means for receiving user input designating video content from a respective device to be utilized for semantic analysis;
means for analyzing the video content to identify one or more salient events; and
means for causing to be provided information regarding designation of the video content for semantic analysis and information regarding the one or more salient events.
